(19) United States
(12) Patent Application Publication
(10) Pub. No.: US 2015/0090611 A1
(43) Pub. Date: Apr. 2, 2015

(54) PRESSURE RELEASE DEVICE FOR ADSORBED GAS SYSTEMS

(71) Applicant: BASF Corporation, Florham Park, NJ (US)

(72) Inventors: William Dolan, Yardley, PA (US); Christoph Garbotz, Mannheim (DE); Adam Lack, New York, NY (US); Joseph Lynch, Sparta, NJ (US); Stefan Marx, Dirmstein (DE); Ulrich Mueller, Neustadt (DE); Michael SantaMaria, Monmouth Junction, NJ (US); Mathias Weickert, Ludwigshafen (DE); Tae Kim, Orange, CA (US)

(21) Appl. No.: 14/498,407

(22) Filed: Sep. 26, 2014

Related U.S. Application Data
(60) Provisional application No. 61/883,603, filed on Sep. 27, 2013.
(60) Provisional application No. 61/883,669, filed on Sep. 27, 2013.
(60) Provisional application No. 61/883,704, filed on Sep. 27, 2013.

(51) Int. Cl. F17C 11/00; B01D 46/24; B01D 46/00

(52) U.S. Cl. CPC F17C 11/007; B01D 46/0005; B01D 46/2403
USPC 206/7; 55/497; 29/428

(57) ABSTRACT

Disclosed in certain embodiments are pressure release devices or filtering devices for adsorbed gas containers in order to increase the safety and efficiencies of adsorbed gas systems. In certain embodiments, the systems contain metal organic framework.

### CROSS REFERENCE TO RELATED APPLICATIONS

This application claims the benefit of priority of U.S. Provisional Patent Application No. 61/883,603, filed Sep. 27, 2013, U.S. Provisional Patent Application No. 61/883,669, filed Sep. 27, 2013, and U.S. Provisional Patent Application No. 61/883,704, filed Sep. 27, 2013, all of which are hereby incorporated by reference herein in their entireties.

### BACKGROUND OF THE DISCLOSURE

Adsorbent materials can be used for the storage of gas. A particular adsorbent, metal organic framework, is a highly crystalline structure with nanometer-sized pores that allow for the storage of natural gas and other gases such as hydrocarbon gas, hydrogen and carbon dioxide. Metal organic framework can also be used in other applications such as gas purification, gas separation and in catalysis.

These materials are typically in particle form and essentially consist of two types of building units: metal ions (e.g. zinc, aluminum) and organic compounds. Each of the organic compounds can attach to at least two metal ions (at least bidentate), serving as a linker for them. In this way a three dimensional, regular framework is spread apart containing empty pores and channels, the sizes of which are defined by the size of the organic linker.

The high surface area provided by metal organic framework can be used for many applications such as gas storage, gas/vapor separation, heat exchange, catalysis, luminescence and drug delivery. By way of example, metal organic framework can have (show) a specific surface area of up to 10,000 m²/g determined by Langmuir model.

A particular application of metal organic framework is for gas storage (e.g., natural gas) in gas powered vehicles. The larger specific surface area and high porosity on the nanometer scale enable metal organic framework to hold relatively large amounts of gases. Used as storage materials in natural gas tanks, metal organic framework offers a docking area for gas molecules, which can be stored in higher densities as a result. The larger gas quantity in the tank can increase the range of a vehicle. The metal organic framework can also increase the usable time of stationary gas powered applications such as generators and machinery.

The adsorbent material (e.g., organic metal framework) that is within the adsorbed gas container is typically in the form of particles. These particles present challenges to the safety and efficiency of the gas powered systems. For instance, the particles may interfere with a container's pressure release device causing safety concerns. Further, the particles may escape the container and infiltrate an associated engine or other component of an associated vehicle resulting in inefficiency or failure. These problems can be exacerbated as the adsorbent particles may partially disintegrate into finer particles.

There exists a need in the art for containment systems and mechanisms to improve safety and efficiency of adsorbed gas systems.

### OBJECTS AND SUMMARY OF THE DISCLOSURE

It is an object of certain embodiments to provide mechanisms to improve efficiencies of adsorbed gas containment systems.

It is an object of certain embodiments to provide mechanisms to improve the safety of adsorbed gas containment systems.

It is an object of certain embodiments to provide a pressure release device that can be utilized in an adsorbed gas containment system.

It is an object of certain embodiments to provide a filtering mechanism for an adsorbed gas containment system to prevent unintended escape of particles.

It is an object of certain embodiments to provide vehicles that incorporate the systems and devices as disclosed herein.

The above objects and others, may be met by the present disclosure, which in certain embodiments is directed to an adsorbed gas containment system including an adsorbed gas container containing adsorption particles and a pressure release device coupled to a wall of the container, the pressure release device having an exterior interface and an interior interface to allow for fluid communication between the interior and the exterior of the container upon activation, the interior interface including a hollow protrusion in fluid communication with the exterior interface and extending into the interior of the container, the hollow protrusion including a plurality of perforations that inhibit entry of the particles into the hollow protrusion.

Other embodiments are directed to a pressure release device including an exterior interface and an interior interface to allow for fluid communication between the interior and the exterior of a container upon activation, the interior interface including a hollow protrusion in fluid communication with the exterior interface and adapted to extend into the interior of a container, the hollow protrusion including a plurality of perforations that are adapted to inhibit entry of particles into the hollow protrusion.

Further embodiments are directed to an adsorbed gas containment system including an adsorbed gas container containing adsorption particles and a pressure release device coupled to a wall of the container, the pressure release device having an exterior interface and an interior interface to allow for fluid communication between the interior and the exterior of the container upon activation, the interior interface including a filter basket in fluid communication with the exterior interface and extending into the interior of the container, the filter basket inhibiting exposure of the exterior interface with the particles.

Additional embodiments are directed to a pressure release device including an exterior interface and an interior interface to allow for fluid communication between the interior and the exterior of a container upon activation, the interior interface including a filter basket in fluid communication with the exterior interface and adapted to extend into the interior of a container, the filter basket adapted with a mesh to inhibit exposure of the exterior interface with particles.

In certain embodiments, the adsorption material utilized in the containment systems is metal organic framework.

Further embodiments are directed to a vehicle including a containment system as disclosed herein.

As used herein, the term “natural gas” refers to a mixture of hydrocarbon gases that occurs naturally beneath the Earth's surface, often with or near petroleum deposits. Natural gas typically includes methane but also may have varying amounts of ethane, propane, butane, and nitrogen.

The terms “adsorbed gas container” or “container suitable for adsorbed gas storage” refer to a container that maintains its integrity when filled or partially filled with an adsorption material that can store a gas. In certain embodiments, the container is suitable to hold the adsorbed gas under pressure or compression.

The terms “vehicle” or “automobile” refer to any motorized machine (e.g., a wheeled motorized machine) for (i) transporting of passengers or cargo or (ii) performing tasks such as construction or excavation. Vehicles can have, e.g., at least 2 wheels (e.g., a motorcycle or motorized scooter), at least 3 wheels (e.g., an all-terrain vehicle), at least 4 wheels (e.g., a passenger automobile), at least 6 wheels, at least 8 wheels, at least 10 wheels, at least 12 wheels, at least 14 wheels, at least 16 wheels or at least 18 wheels. The vehicle can be, e.g., a bus, refuse vehicle, freight truck, construction vehicle, heavy equipment, military vehicle or tractor. The vehicle can also be a train, aircraft, watercraft, submarine or spacecraft.

The term “activation” refers to the treatment of adsorption materials (e.g., metal organic framework particles) in a manner to increase their storage capacity. Typically, the treatment results in removal of contaminants (e.g., water, non-aqueous solvent, sulfur compounds and higher hydrocarbons) from adsorption sites in order to increase the capacity of the materials for their intended purpose.

The term “adsorbent material” refers to a material (e.g., adsorbent particles) that can adhere gas molecules within its structure for subsequent use in an application. Specific materials include but are not limited to metal organic framework, activated alumina, silica gel, activated carbon, molecular sieve carbon, zeolites (e.g., molecular sieve zeolites), polymers, resins and clays.

The term “particles” when referring to adsorbent materials such as metal organic framework refers to multiparticulates of the material having any suitable size such as 0.0001 mm to about 50 mm or 1 mm to 20 mm. The morphology of the particles may be crystalline, semi-crystalline, or amorphous. The term also encompasses powders and particles down to 1 nm. The size ranges disclosed herein can be mean or median size.

The term “monolith” when referring to absorbent materials refers to a single block of the material. The single block can be in the form of, e.g., a brick, a disk or a rod and can contain channels for increased gas flow/distribution. In certain embodiments, multiple monoliths can be arranged together to form a desired shape.

The term “fluidly connected” refers to two or more components that are arranged in such a manner that a fluid (e.g., a gas) can travel from one component to another component either directly or indirectly (e.g., through other components or a series of connectors).

The term “freely settled density” or “bulk density” is determined by measuring the volume of a known mass of particles. The measurement can be determined using the procedures described in Method I or Method II of the United States Pharmacopeia 26, section <616>, hereby incorporated by reference.

The term “tapped density” is determined by measuring the volume of a known mass of particles after agitating the materials or container or using any of the filling techniques disclosed herein. The measurement can be determined by modifying procedures described in Method I or Method II of the United States Pharmacopeia 26, section <616>, hereby incorporated by reference. The procedures therein can be modified to provide a “tapped density” after any physical manipulation of the container and/or particles, e.g., after vibrating the container or using the filling techniques as disclosed herein. The measurement can also be determined using modification of DIN 787-11 (ASTM B527).

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment, “certain” embodiments, or “some” embodiments in this disclosure are not necessarily to the same embodiment, and such references mean at least one.

FIGS. 1A and 1B depict a pressure release device of the present disclosure;

FIG. 2 depicts an adsorbed gas containment system with a filter according to an embodiment of the disclosure;

FIG. 3A depicts gas entering an adsorbed gas container during filling;

FIG. 3B depicts gas leaving the container during system operation; and

FIG. 4 is a flow diagram illustrating a method for utilizing an adsorbed gas container system in a vehicle according to an embodiment of the disclosure.

### DETAILED DESCRIPTION

Adsorption materials (e.g., metal organic framework) are capable of storing large amounts of gas for subsequent use in applications such as gas powered vehicles. When the containers that hold the adsorbent materials are depressurized as a result of consumption of the gas contained therein, a significant amount of the gas can remain adsorbed on the materials. As vehicles require high pressure for operation (e.g., a fuel injector may require pressures of greater than about 150 psi, or up to 500 psi or more) the adsorbed gas at low pressure is not accessible to fuel the engine. This results in an inefficient utilization of fuel which is addressed by certain embodiments of the disclosure.

Another efficiency and environmental issue associated with gasoline powered vehicles and bi-fuel vehicles (e.g., running on both gasoline and compressed or adsorbed gas) is the emission of vapors from the gasoline, especially on hot days. This vapor is an environmental concern as well as an efficiency issue as the vapors are entering the environment unutilized. This concern is addressed by certain embodiments of the disclosure.

### Pressure Release Device

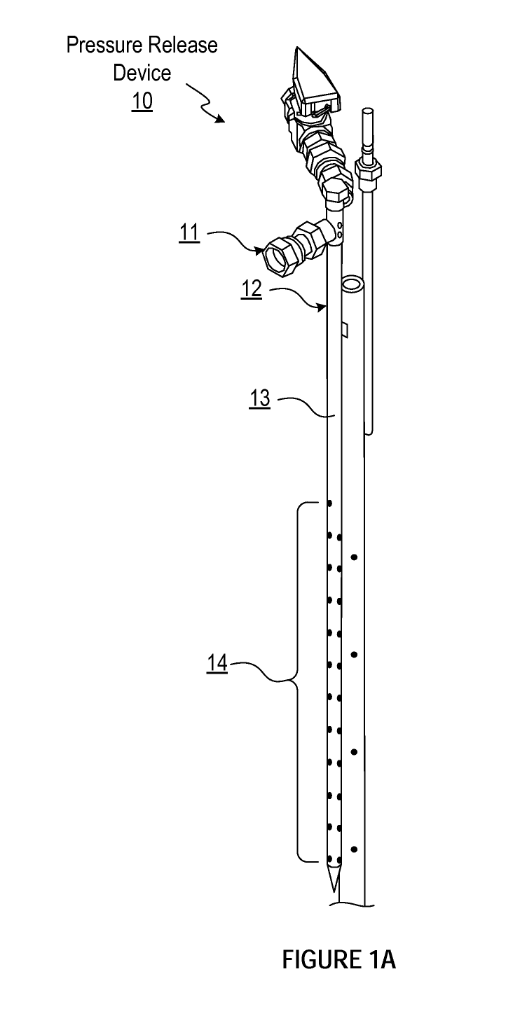

As depicted in FIG. 1A, one embodiment is directed to a pressure release device (10) including an exterior interface (11) and an interior interface (12) to allow for fluid communication between the interior and the exterior of a container upon activation, the interior interface including a hollow protrusion (13) in fluid communication with the exterior interface and adapted to extend into the interior of a container, the hollow protrusion including a plurality of perforations (14) that are adapted to inhibit entry of particles into the hollow protrusion. FIG. 1B shoes a housing (15) for fitting onto a container.

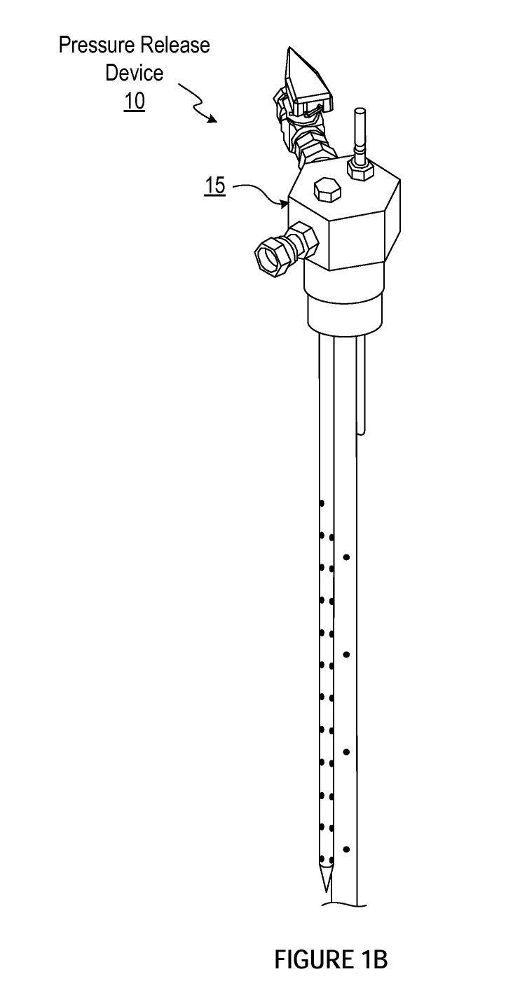

As depicted in FIG. 2, one embodiment is directed to a pressure release device (20) including an exterior interface (21) and an interior interface (22) to allow for fluid communication between the interior and the exterior of a container upon activation, the interior interface including a filter basket (23) in fluid communication with the exterior interface and adapted to be proximate to or to extend into the interior of a container, the filter basket adapted to inhibit exposure of the exterior interface with particles.

Certain embodiments are directed to an adsorbed gas containment system including an adsorbed gas container containing adsorption particles; and a pressure release device coupled to a wall of the container, the pressure release device having an exterior interface and an interior interface to allow for fluid communication between the interior and the exterior of the container upon activation, the interior interface including a hollow protrusion in fluid communication with the exterior interface and extending into the interior of the container, the hollow protrusion including a plurality of perforations that inhibit entry of the particles into the hollow protrusion.

Another embodiment is directed to an adsorbed gas containment system including an adsorbed gas container containing adsorption particles; and a pressure release device coupled to a wall of the container, the pressure release device having an exterior interface and an interior interface to allow for fluid communication between the interior and the exterior of the container upon activation, the interior interface including a filter basket in fluid communication with the exterior interface and extending into the interior of the container, the filter basket inhibiting exposure of the exterior interface with the particles.

The protrusion can be in any suitable configuration in order to be a conduit between the interior and exterior of a container, e.g., in the form of a tube, a bulb, or an irregular shape.

The perforations of the device can be of any geometry to inhibit the influx of adsorption particles, thus preventing potential interference with the release interface. At least a portion of the perforations in certain embodiments are in the form of slots, circles, ellipses or a combination thereof. The perforations are sized, e.g., to have a diameter or largest width that is less than the mean diameter or smallest axis of the particles. In order to allow for normal operation, the perforations should collectively allow for sufficient evacuation of gas from the container through the pressure release device upon system activation.

The system activation may be based on an elevated pressure as compared to the container specification. The system activation may also be based on an elevated temperature as compared to the container specification. Certain embodiments may also base system activation on a combination of both temperature and pressure. In order to active the system according to these parameters, certain embodiments further include one or both of a pressure monitor in communication with the pressure release device, a temperature monitor in communication with the pressure release device.

In certain embodiments, the exterior interface of the pressure release device includes a pressure release valve, a rupture disk, a fusible plug, or a combination thereof.

In certain embodiments, the containment system may include a filter. The filter can be within the hollow protrusion or in the interior of the container in proximity to the exterior interface.

In certain embodiments, the containment systems disclosed herein include a gas fill line in fluid communication with the hollow protrusion. In such embodiments, the perforations should collectively allow for sufficient filling of gas into the container through the gas fill line. In certain embodiments, a filter can be in fluid communication with the exterior interface and the gas fill line. Optionally, the gas fill line is capable of clearing particles from the filter upon introduction of a gas.

The filters described herein can be a screen, mesh, fibrous material, fabric, woven material, non-woven material or any other suitable material.

### Filtering System

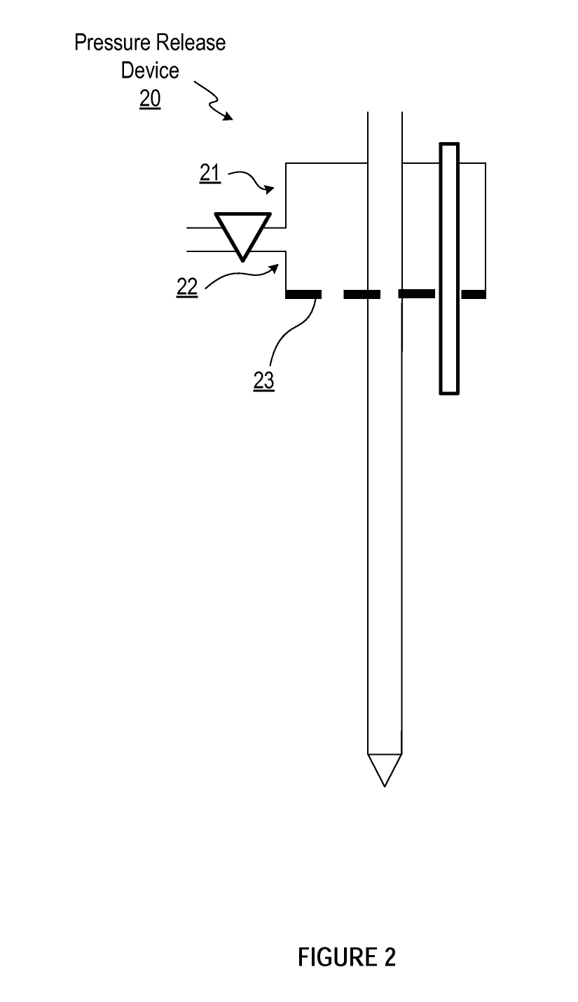

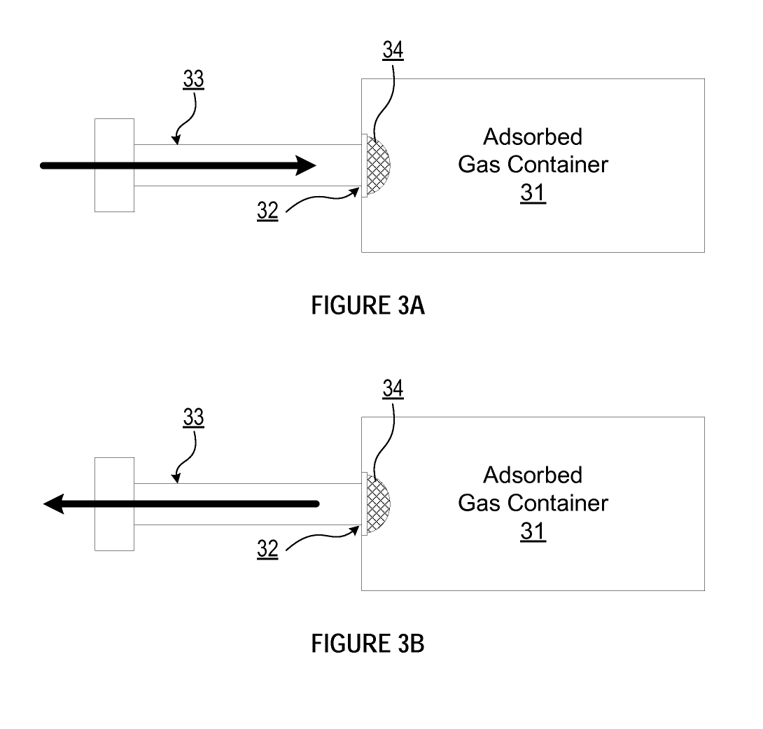

As depicted in FIGS. 3A and 3B, certain embodiments are directed to an adsorbed gas containment system (30) including an adsorbed gas container (31) including an orifice (32) and containing adsorption particles; a gas line (33) in fluid communication with the container through the orifice (32), the gas line (33) configured to introduce a gas into the container (31) and to allow a gas to exit the container (31); and a filter (34) located at a point of gas flow, the filter (34) adapted to allow for gas flow between the gas line (33) and the container (31) and to minimize the passage of adsorption particles out of the container (31). FIG. 3A depicts gas entering the container (31) during filling, and FIG. 3B depicts gas leaving the container (31) during system operation.

Other embodiments are directed to an adsorbed gas containment system including an adsorbed gas container containing adsorption particles; a gas fill line for introducing a gas into the container; a gas exit line to allow a gas to exit the container; a filter located at a point of gas flow proximal to the gas exit line to minimize the adsorption particles from exiting the container; and a second filter at a point of gas flow proximal to the gas fill line adapted to allow for gas flow into the container.

The disclosed filters described herein can be a screen, mesh, fibrous material or any other suitable material. The filter can also be any suitable shape such as substantially flat, concave in the direction of gas flow into the container or convex into the direction of gas flow into the container. Optionally the introduction of gas through the gas fill line is capable of clearing particles from the filter.

The disclosed filters can be located at any suitable position, e.g., within the container and covering the orifice or within the gas line. Certain embodiments include multiple filters at different locations.

The filters can be stationary (i.e., a fixed part of the container) or removable (e.g., in the form of a cartridge). This would allow for periodic maintenance without replacing the entire container.

In certain embodiments, the filter minimizes contaminants from entering the gas container during filling. These contaminants may be materials selected from the group consisting of moisture, oil, particulates and a combination thereof.

In certain embodiments, the largest width of the screen or mesh size of the filters should be less than the mean diameter of the particles or the mean smallest axis of the particles. In certain embodiments, the screen or mesh size can be about 15 microns or less, about 10 microns or less, about 8 microns or less, about 5 microns or less or about 3 microns or less.

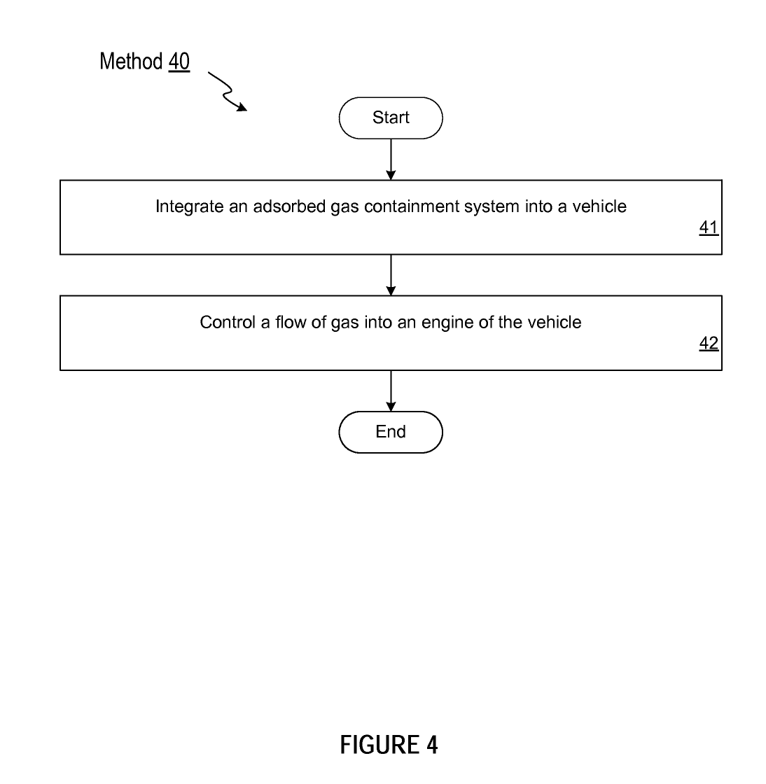

FIG. 4 is a flow diagram illustrating a method for utilizing an adsorbed gas container system in a vehicle according to an embodiment of the disclosure. At block 41, an adsorbed gas containment system is integrated into a vehicle. The adsorbed gas containment system may correspond to any of the adsorbed gas containment systems described herein. At block 42, a flow of gas into an engine of the vehicle is controlled.

### General Fuel System Embodiments

The disclosed fuel systems (e.g., adsorbed gas extraction or gasoline vapor recovery systems) may include containers such as cylinders, tanks or any other container that is suitable for storing adsorbed gas. The container can be suitable for adsorption, containment, and/or transportation of natural gas, hydrocarbon gas (e.g., methane, ethane, butane, propane, pentane, hexane, isomers thereof and a combination thereof), air, oxygen, nitrogen, synthetic gas, hydrogen, carbon monoxide, carbon dioxide, helium, or any other gas, or combinations thereof that can be adsorbed in a container for a variety of uses.

The fuel systems can be suitable for use in a compressed gas vehicle (such as a road vehicle or an off-road vehicle) or in heavy equipment (such as generators and construction equipment). In certain embodiments, the fuel system is adapted to contain a quantity of compressed gas to provide a range of operation for a vehicle of about 100 miles or more, or about 200 miles or more.

The vehicle can have, e.g., at least 2 wheels (e.g., a motorcycle or motorized scooter), at least 3 wheels (e.g., an all-terrain vehicle), at least 4 wheels (e.g., a passenger automobile), at least 6 wheels, at least 8 wheels, at least 10 wheels, at least 12 wheels, at least 14 wheels, at least 16 wheels or at least 18 wheels. The vehicle can be, e.g., a bus, refuse vehicle, freight truck, construction vehicle, or tractor.

The adsorption container of the fuel systems can have a capacity, e.g., of at least about 1 liter, at least about 5 liters, at least about 10 liters, at least about 50 liters, at least about 75 liters, at least about 100 liters, at least about 200 liters, or at least about 400 liters. In certain embodiments, a vehicle fuel system can include multiple containers (e.g., tanks), e.g., at least 2 containers, at least 4 containers, at least 6 containers or at least 8 containers. In certain embodiment, the fuel system can contain 2 containers, 3 containers, 4 containers, 5 containers, 6 containers, 7 containers, 8 containers, 9 containers or 10 containers.

When filled into the containers of the disclosed fuel systems, the ratio of the tapped density of the particles to the ratio of the freely settled density of the particles can be greater than 1, e.g., at least about 1.1, at least about 1.2, at least about 1.5, at least about 1.7, at least about 2.0 or at least about 2.5.

The adsorbent material (e.g., particles) that may be utilized using the methods disclosed herein can be metal organic framework, e.g., having a surface area of at least about 500 m²/g, at least about 700 m²/g, at least about 1000 m²/g, at least about 1200 m²/g, at least about 1500 m²/g, at least about 1700 m²/g, at least about 2000 m²/g, at least about 5000 m²/g or at least about 10,000 m²/g.

The surface area of the material may be determined by the BET (Brunauer-Emmett-Teller) method according to DIN ISO 9277:2003-05 (which is a revised version of DIN 66131). The specific surface area is determined by a multipoint BET measurement in the relative pressure range from 0.05-0.3 p/p₀.

In certain embodiments the adsorbent material includes a zeolite. In certain embodiments a chemical formula of the zeolite is of a form of M_{x/n}[(AlO₂)ₓ(SiO₂)_{y}]·mH₂O, where x, y, m, and n are integers greater than or equal to 0, and M is a metal selected from the group consisting of Na and K.

In other embodiments the adsorbent material is a zeolitic material in which the framework structure is composed of YO₂ and X₂O₃, in which Y is a tetravalent element and X is a trivalent element. In one embodiment Y is selected from the group consisting of Si, Sn, Ti, Zr, Ge, and combinations of two or more thereof. In one embodiment Y is selected from the group consisting of Si, Ti, Zr, and combinations of two or more thereof. In one embodiment Y is Si and/or Sn. In one embodiment Y is Si. In one embodiment X is selected from the group consisting of Al, B, In, Ga, and combinations of two or more thereof. In one embodiment X is selected from the group consisting of Al, B, In, and combinations of two or more thereof. In one embodiment X is Al and/or B. In one embodiment X is Al.

In certain embodiments, the metal organic framework particles may include a metal selected from the group consisting of Li, Mg, Ca, Sc, Y, Zr, V, Mn, Fe, Co, Ni, Cu, Zn, B, Al, Ti and a combination thereof. In certain embodiments, the MOF particles include a metal selected from the group consisting of Al, Mg, Zn, Cu, Zr, and a combination thereof.

In certain embodiments, the bidentate organic linker has at least two atoms which are selected independently from the group consisting of oxygen, sulfur and nitrogen via which an organic compound can coordinate to the metal. These atoms can be part of the skeleton of the organic compound or be functional groups. In certain embodiments the MOF particles include a moiety selected from the group consisting of a phenyl moiety, an imidazole moiety, an alkane moiety, an alkyne moiety, a pyridine moiety, a pyrazole moiety, an oxole moiety, and a combination thereof. In certain embodiments the MOF particles include at least one moiety selected from the group consisting of fumaric acid, formic acid, 2-methylimidazole, and trimesic acid.

As functional groups through which the abovementioned coordinate bonds can be formed, mention may be made by way of example of, in particular: OH, SH, NH₂, NH(—R—H), N(R—H)₂, CH₂OH, CH₂SH, CH₂NH₂, CH₂NH(—R—H), CH₂N(—R—H)₂, —CO₂H, COSH, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H₂, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃ —CH(RCN)₂, —C(RCN)₃, where R may be, for example, an alkylene group having 1, 2, 3, 4 or 5 carbon atoms, for example a methylene, ethylene, n-propylene, isopropylene, n-butylene, isobutylene, tert-butylene or n-pentylene group, or an aryl group having 1 or 2 aromatic rings, for example 2 C₆ rings, which may, if appropriate, be fused and may, independently of one another, be appropriately substituted by, in each case, at least one substituent and/or may, independently of one another, include, in each case, at least one heteroatom, for example N, O and/or S. In likewise embodiments, mention may be made of functional groups in which the abovementioned radical R is not present. In this regard, mention may be made of, inter alia, —CH(SH)₂, —C(SH)₃, —CH(NH₂)₂, CH(NH(R—H))₂, CH(N(R—H)₂)₂, C(NH(R—H))₃, C(N(R—H)₂)₃, —C(NH₂)₃, —CH(OH)₂, —C(OH)₃, —CH(CN)₂, —C(CN)₃.

The at least two functional groups can in principle be bound to any suitable organic compound as long as it is ensured that the organic compound including these functional groups is capable of forming the coordinate bond and of producing the framework.

The organic compounds which include the at least two functional groups are derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. The aliphatic compound or the aliphatic part of the both aliphatic and aromatic compound may include from 1 to 18, 1 to 14, 1 to 13, 1 to 12, 1 to 11, or 1 to 10 carbon atoms, for example 1, 2, 3, 4, 5, 6, 7, 8, 9 or 10 carbon atoms. For example, certain embodiments may include, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings being able to be present in fused form. The aromatic compound or the aromatic part of the both aliphatic and aromatic compound particularly may have one, two, or three rings. Furthermore, each ring of the compound can include, independently of one another, at least one heteroatom such as N, O, S, B, P, and/or Si. The aromatic compound or the aromatic part of the both aromatic and aliphatic compound may include one or two C₆ rings; in the case of two rings, they can be present either separately from one another or in fused form. Aromatic compounds of which particular mention may be made are benzene, naphthalene and/or biphenyl and/or bipyridyl and/or pyridyl.

The at least bidentate organic compound may be derived from a dicarboxylic, tricarboxylic or tetracarboxylic acid or a sulfur analogue thereof. Sulfur analogues are the functional groups —C(═O)SH and its tautomer and C(═S)SH, which can be used in place of one or more carboxylic acid groups.

For the purposes of the present disclosure, the term “derived” means that the at least bidentate organic compound can be present in partly deprotonated or completely deprotonated form in a MOF subunit or MOF-based material. Furthermore, the at least bidentate organic compound can include further substituents such as —OH, —NH₂, —OCH₃, —CH₃, —NH(CH₃), —N(CH₃)₂, —CN and halides. In certain embodiments, the at least bidentate organic compound may be an aliphatic or aromatic acyclic or cyclic hydrocarbon which has from 1 to 18 carbon atoms and, in addition, has exclusively at least two carboxy groups as functional groups.

For the purposes of the present disclosure, mention may be made by way of example of dicarboxylic acids, as may be used to realize any of the embodiments disclosed herein, such as oxalic acid, succinic acid, tartaric acid, 1,4-butanedicarboxylic acid, 1,4-butene-dicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxyolic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxa-octanedicarboxylic acid, 3,5-cyclohexadiene-1,2-dicarboxylic acid, octadicarboxylic acid, pentane-3,3-dicarboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxyl)phenyl-3-(4-chloro)phenyl-pyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, (bis(4-aminophenyl) ether)diimidedicarboxylic acid, 4,4′-diaminodiphenylmethanediimidedicarboxylic acid, (bis(4-aminophenyl) sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptadicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydro-anthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid or camphordicarboxylic acid, tricarboxylic acids such as 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid, or tetracarboxylic acids such as 1,1-dioxidoperylo[1,12-BCD]thiophene-3,4,9,10-tetracarboxylic acid, perylene-tetracarboxylic acids such as perylene-3,4,9,10-tetracarboxylic acid or (perylene 1,12-sulfone)-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenone-tetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

Certain embodiments may use at least monosubstituted aromatic dicarboxylic, tricarboxylic or tetracarboxylic acids which have one, two, three, four or more rings and in which each of the rings can include at least one heteroatom, with two or more rings being able to include identical or different heteroatoms. For example, certain embodiments may use one-ring dicarboxylic acids, one-ring tricarboxylic acids, one-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, and/or P. Suitable substituents which may be mentioned in this respect are, inter alia, —OH, a nitro group, an amino group or an alkyl or alkoxy group.

In certain embodiments, the linker may include a moiety selected from the group consisting of a phenyl moiety, an imidazole moiety, an alkane moiety, an alkyne moiety, a pyridine moiety, a pyrazole moiety, an oxole moiety and a combination thereof. In a particular embodiment, the linker may be a moiety selected from any of the moieties illustrated in Table 1.

TABLE 1
Linker Moieties

| | |
|---|---|
| Moiety 1 | 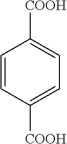 [SMILES: O=C(O)c1ccc(C(=O)O)cc1] |
| Moiety 2 | 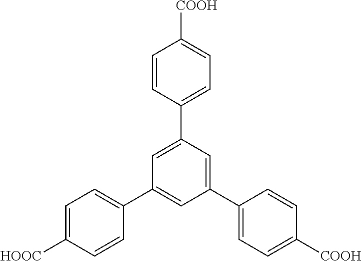 [SMILES: O=C(O)c1ccc(-c2cc(-c3ccc(C(=O)O)cc3)cc(-c3ccc(C(=O)O)cc3)c2)cc1] |
| Moiety 3 | 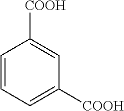 [SMILES: O=C(O)c1cccc(C(=O)O)c1] |
| Moiety 4 | 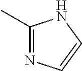 |
| Moiety 5 | 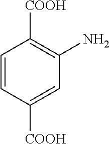 [SMILES: Nc1cc(C(=O)O)ccc1C(=O)O] |
| Moiety 6 | 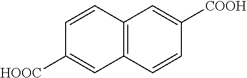 [SMILES: O=C(O)c1ccc2cc(C(=O)O)ccc2c1] |
| Moiety 7 | 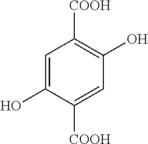 [SMILES: O=C(O)c1cc(O)c(C(=O)O)cc1O] |
| Moiety 8 | 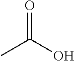 |
| Moiety 9 | 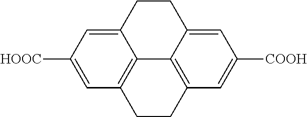 [SMILES: O=C(O)c1cc2c3c(c1)CCc1cc(C(=O)O)cc(c1-3)CC2] |
| Moiety 10 | 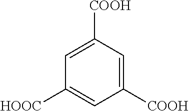 [SMILES: O=C(O)c1cc(C(=O)O)cc(C(=O)O)c1] |
| Moiety 11 | 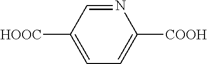 [SMILES: O=C(O)c1ccc(C(=O)O)nc1] |
| Moiety 12 | 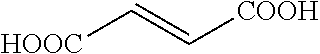 |
| Moiety 13 | 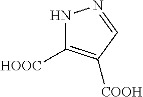 [SMILES: O=C(O)c1cn[nH]c1C(=O)O] |
| Moiety 14 | 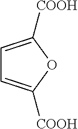 [SMILES: O=C(O)c1ccc(C(=O)O)o1] |
| Moiety 15 | 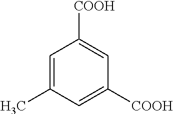 |

The MOF particles can be in any form, such as, e.g., pellets, extrudates, beads, powders or any other defined or irregular shape. The particles can be any size, e.g., from about 0.0001 mm to about 10 mm, from about 0.001 to about 5 mm, from about 0.01 to about 3 mm, or from about 0.1 mm to about 1 mm.

One embodiment is directed to the fuel systems disclosed herein with a containment system including a container suitable for adsorbed gas storage having a capacity of at least 1 liter at least partially filled with metal organic framework particles such that the ratio of the tapped density of the particles to the ratio of the freely settled density of the particles is at least 1.1. Still further embodiments are directed to vehicles including the fuel systems as disclosed herein. Other embodiments are directed to methods of manufacturing such vehicles by integrating a fuel system as disclosed herein into a vehicle.

The disclosed fuels systems can be part of an assembly of a new vehicle or can be retrofitted into an existing vehicle. Also disclosed herein are methods of operating a vehicle including controlling the amount of gas being utilized by a vehicle including a fuel system as disclosed herein.

### Methods of Filling Containers

In certain embodiments, the fuel systems can include a container suitable for adsorbed gas storage having a capacity of at least 1 liter and at least partially filled with metal organic framework particles such that (i) the ratio of the tapped density of the particles to the ratio of the freely settled density of the particles greater than 1 (e.g., 1.1 or more) or (ii) the tapped density is, depending on the selection of materials, e.g., from about 0.1 g/cm³ to about 10 g/cm³, from about 0.2 g/cm³ to about 5 g/cm³, from about 0.3 g/cm³ to about 0.8 g/cm³, or from about 0.2 g/cm³ to about 1 g/cm³.

The filling process may include shifting or moving (intermittently or constantly) the container during at least a portion of the filling. Alternatively, or in addition, the filling may include shifting, moving, or vibrating the container after the filling with the metal organic framework particles. The shifting or moving of the container may include, e.g., shaking, rolling, vibrating or subjection to centrifugal force.

The filling process may also include the use of a tube to transfer the metal organic framework particles from a storage vessel to the container. The tube can be any suitable dimension such as, e.g., an elongated cylinder. A funnel may also be utilized in the filling process. The funnel can be incorporated as an integral part of the tube or can be a separate apparatus that is connected with the tube.

During the filling process, the container can be positioned such that the stream of particles during the filling is downward. In a particular embodiment, the stream of particles during the filling is downward at any suitable angle to effect filling, e.g., at an angle of between about 135° and about 225° from a vertical axis.

In order to minimize the exposure of filling material to contaminants, the tube can be sealed to the container inlet during the filling, sealed to the storage vessel outlet during the filling or sealed to both the container inlet and the storage vessel outlet during the filling.

In certain embodiments, the tube is at an initial position at the start of the filling and the tube is raised upward to a second position at the end of the filling. The tube may be raised intermittently or constantly from the initial position to the second position during the filling. Further, the tube may be raised at a fixed rate or at a varied rate from the initial position to the second position during the filling. In still further embodiments, the tube is raised linearly or non-linearly (e.g., in a circular or corkscrew manner) from the initial position to the second position during the filling.

The filling process may also include the manipulation of the particles in order to facilitate the process. Such manipulations may include, e.g., surface roughness control, low friction coatings, electrostatic charge reduction, or any other suitable parameters that may facilitate loading.

In certain embodiments, the metal organic framework particles can be incorporated into a matrix material and thereafter introduced into a container. The matrix may be a plastic material in any suitable form such as a sheet which can be formed, e.g., by extrusion. The material can be optionally corrugated. The material can be rolled or otherwise manipulated and incorporated into a container. Prior to introduction into a container, the material can be bound by polymer fibers.

Activation of Particles

The disclosed fuel systems can include activated adsorption particles (e.g., metal organic framework particles) wherein the adsorption particles are subjected to conditions selected from the group consisting of above ambient temperature, vacuum, an inert gas flow and a combination thereof, for a sufficient time to activate the particles.

In certain embodiments, the activation includes the removal of water molecules from the adsorption sites. In other embodiments, the activation includes the removal of non-aqueous solvent molecules from the adsorption sites that are residual from the manufacture of the particles. In still further embodiments, the activation includes the removal of sulfur compounds or higher hydrocarbons from the adsorption sites. In embodiments utilizing an inert gas purge in the activation process, a subsequent solvent recovery step is also contemplated. In certain embodiments, the contaminants (e.g., water, non-aqueous solvents, sulfur compounds or higher hydrocarbons) are removed from the adsorption material at a molecular level.

In a particular embodiment, the activation includes the removal of water molecules from the surface area of the particles. After activation, the particles may have a moisture content of less than about 10%, less than about 8%, less than about 5%, less than about 3%, less than about 1%, less than about 0.8%, less than about 0.5%, less than about 0.3% or less than about 0.1% by weight of the particles. Alternatively, the available surface area of the adsorption material for adsorption of the intended gas is greater than about 80%, greater than about 85%, greater than about 90%, greater than about 95% or greater than about 98% of the accepted value (i.e., the theoretical surface area free of adsorbed contaminants).

The activation can occur before or after the particles are filled into a container suitable for adsorbed gas storage. Alternatively, the particles are activated external to a container suitable for adsorbed gas storage. Activating particles outside of the container may be beneficial in certain circumstances as the container may have temperature limitations that may impede the activation process. The external process may also result in a shorter activation time due to the ability to apply a higher temperature to the particles outside of the tank.

Certain embodiments are directed to the activation of metal organic framework particles. The particles can be subject to a suitable temperature for removal of contaminants (e.g., water, non-aqueous solvents, sulfur compounds and higher hydrocarbons) from adsorption sites. The activation may include exposure of the metal organic framework particles to a temperature, e.g., above about 40° C., above about 60° C., above about 100° C., above about 150° C., above about 250° C., or above about 350° C. In other embodiments, the temperature may be between about 40° C. and about 400° C., between about 60° C. and about 250° C., between about 100° C. and about 200° C., between about 60° C. and about 200° C., between about 60° C. and about 180° C., between about 60° C. and about 170° C., between about 60° C. and about 160° C., between about 150° C. and about 200° C. or between about 150° C. and about 180° C.

The activation of particles may be subject to a vacuum in order to remove contaminants (e.g., water, non-aqueous solvents, sulfur compounds and higher hydrocarbons) from adsorption sites. The vacuum may be, e.g., from about 10% to about 80% below atmospheric pressure, from about 10% to about 50% below atmospheric pressure, from about 10% to about 20% below atmospheric pressure, from about 20% to about 30% below atmospheric pressure or from about 30% to about 40% below atmospheric pressure.

The activation of the particles can also include flowing inert gas through the material to remove contaminants (e.g., water, non-aqueous solvents, sulfur compounds and higher hydrocarbons). The inert gas flow can include nitrogen or a noble gas. The total amount of inert gas used in the purge can be any suitable amount to activate the materials. In a particular embodiment, the amount of gas is at least the volume of a container holding the particles. In other embodiments, the amount of gas is at least 2 times the container volume or at least 3 times the container volume. The inert gas can be flowed through the materials for any suitable time, such as at least about 1 hour, at least about 6 hours, at least about 8 hours, at least about 16 hours, at least about 24 hours or at least about 48 hours. Alternatively, the time can be from about 1 hour to about 48 hours, from about 2 hours to about 24 hours or from about 4 hours to about 16 hours.

Any amount of adsorbent material (e.g., MOF particles) may be activated according to the methods described herein, or a combination thereof. In a particular embodiment, the particles may be in an amount of at least about 1 kg, at least about 500 kg, from about 20 kg to about 500 kg, from about 50 kg to about 300 kg or from about 100 kg to about 200 kg. In another embodiment, the adsorbent material may be in an amount of at least about 1 g, at least about 500 g, from about 20 g to about 500 g, from about 50 g to about 300 g, from about 100 g to about 200 g, or greater than 500 g.

The activated particles can be at least partially filled into a container suitable for compressed gas storage, e.g., having a capacity of at least about 1 liter. The filling can optionally encompass any of the filling procedures disclosed herein. The filling of activated particles may also result in the tapped density of particles disclosed herein.

After the particles are filled into a suitable adsorption container, the activation can occur by placing the container in an oven. Alternatively, if the container is mounted onto a vehicle or machinery (e.g., a generator), a heat source internal to the vehicle or machinery can be used. For example, the heat source in a vehicle may be derived from the battery, engine, the air conditioning unit, the brake system, or a combination thereof. In alternative embodiments, the container at least partially filled with particles can be activated with an external heat source.

In other embodiments, if the container is mounted onto a vehicle or machinery, a vacuum source internal or external to the vehicle or machinery can be used for activation. For example, the energy source in a vehicle for the internal vacuum may be derived from the battery, engine, the air conditioning unit, the brake system, or a combination thereof.

In embodiments wherein the container is mounted onto a vehicle or machinery, it may be necessary at a point in time after the initial activation to re-activate the particles. For instance, after one or more cycles wherein the container is filled with a compressed gas with subsequent release (e.g., upon running the vehicle), certain contaminants may remain on the adsorption sites. These contaminants may include sulfur compounds or higher hydrocarbons (e.g., C₄₋₆ hydrocarbons). The reactivation can include subjecting the particles in the container to heat, vacuum and/or inert gas flow for a sufficient time for reactivation. In one embodiment, the reactivation can occur at a service visit or can be performed at a standard fueling station. The reactivation can also include washing and/or extraction of the particles in the container with non-aqueous solvent or water.

The time period for the activation or reactivation of the particles can be determined by measuring the flow of water or non-aqueous solvent in a vacuum. In a certain embodiment, the flow is terminated when the water or solvent content is less than about 10%, less than about 8%, less than about 5%, less than about 3%, less than about 1%, less than about 0.8%, less than about 0.5%, less than about 0.3% or less than about 0.1% by weight of the particles.

In certain embodiments, the container can include a heating element in order to provide activation of the materials after filling. The energy for the heating element can be provided internally from the vehicle (e.g., from a battery, engine, air conditioning unit, brake system, or a combination thereof) or externally from the vehicle. Whether the activation is before or after filling, the container may be dried prior to the introduction of particles into the container. The container can be dried, e.g., with air, ethanol, heat or a combination thereof.

When the particles are activated outside of the container, it may be necessary to store and/or ship the particles prior to incorporation into an adsorption container. In certain embodiments, the activated particles are stored in a plastic receptacle with an optional barrier layer between the receptacle and the particles. The barrier layer may include, e.g., one or more plastic layers.

When the particles are activated by an inert gas flow, the flow may be initiated at an inlet of the container and may be terminated at an outlet of the container at a different location than the inlet. In alternative embodiments, the inert gas flow is initiated and terminated at the same location on the container.

The inert gas flow may include the utilization of a single tube for introducing and removing the inert gas from the container. In such an embodiment, the tube may include an outer section with at least one opening to allow the inert gas to enter the container and an inner section without openings to allow for the inert gas to be removed from the container. In other embodiments, the flow may include the utilization of a first tube for introducing the inert gas into the container and a second tube to remove the inert gas from the container.

Disclosure herein specifically directed to metal organic framework is also contemplated to be applicable to other adsorbent materials such as activated alumina, silica gel, activated carbon, molecular sieve carbon, zeolites (e.g., molecular sieve zeolites), polymers, resins and clays.

Also, disclosure herein with respect to adsorbent particles is also contemplated to be applicable to monoliths of the material where applicable.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present invention has been described with reference to specific exemplary embodiments thereof. It will, however, be evident that various modifications and changes may be made thereto without departing from the broader scope of the embodiments of the invention as set for in the appended claims. The specification and drawings are, accordingly, to be regarded in an illustrative rather than a restrictive sense.

1. An adsorbed gas containment system comprising:
an adsorbed gas container containing adsorption particles; and
a pressure release device coupled to a wall of the container, the pressure release device having an exterior interface and an interior interface to allow for fluid communication between the interior and the exterior of the container upon activation, the interior interface comprising a hollow protrusion in fluid communication with the exterior interface and extending into the interior of the container, the hollow protrusion comprising a plurality of perforations that inhibit entry of the particles into the hollow protrusion.

2. The containment system of claim 1, wherein the protrusion is in a form of a tube, a bulb, or an irregular shape.

3. The containment system of claim 1, wherein at least a portion of the perforations are in a form of slots or circles or ellipses.

4. The containment system of claim 1, wherein the perforations have a diameter or largest width that is less than a mean diameter or smallest axis of the particles.

5. The containment system of claim 1, wherein the perforations collectively allow for sufficient evacuation of gas from the container through the pressure release device upon activation.

6. The containment system of claim 1, wherein the activation is based on an elevated pressure as compared to a specification of the container.

7. The containment system of claim 1, wherein the activation is based on an elevated temperature as compared to a specification of the container.

8. The containment system of claim 6, further comprising a pressure monitor in communication with the pressure release device.

9. The containment system of claim 7, further comprising a temperature monitor in communication with the pressure release device.

10. The containment system of claim 1, wherein the exterior interface comprises a pressure release valve.

11. The containment system of claim 1, wherein the exterior interface comprises a rupture disk.

12. The containment system of claim 1, wherein the exterior interface comprises a fusible plug.

13. The containment system of claim 1, further comprising a filter.

14. The containment system of claim 13, wherein the filter is within the hollow protrusion.

15. The containment system of claim 13, wherein the filter is in the interior of the container in proximity to the exterior interface.

16. The containment system of claim 1, further comprising a gas fill line in fluid communication with the hollow protrusion.

17. The containment system of claim 16, wherein the perforations collectively allow for sufficient filling of gas into the container through the gas fill line.

18. The containment system of claim 16, wherein the filter is in fluid communication with the exterior interface and the gas fill line.

19. The containment system of claim 18, wherein an introduction of gas through the gas fill line is capable of clearing particles from the filter.

20. The containment system of claim 13, wherein the filter is a screen, mesh, fibrous material, fabric, woven material, non-woven material.

21. A pressure release device comprising an exterior interface and an interior interface to allow for fluid communication between an interior and an exterior of a container upon activation, the interior interface comprising a hollow protrusion in fluid communication with the exterior interface and adapted to extend into the interior of the container, the hollow protrusion comprising a plurality of perforations that are adapted to inhibit entry of particles into the hollow protrusion.

22-39. (canceled)

40. The containment system of claim 1, containing metal organic framework particles.

41. (canceled)

42. (canceled)

43. The containment system of claim 1, adapted to contain a quantity of compressed gas to provide a range of vehicle operation of about 100 miles or more.

44. (canceled)

45. The containment system of claim 1, integrated with a vehicle.

46-48. (canceled)

49. The containment system of claim 1, wherein the container has a capacity of at least about 1 liter and is at least partially filled with activated metal organic framework particles.

50-61. (canceled)

62. The containment system of claim 40, wherein the metal organic framework particles have a surface area of at least about 500 m²/g.

63-68. (canceled)

69. The containment system of claim 40, wherein the metal organic framework particles comprise a metal selected from the group consisting of Li, Mg, Ca, Sc, Y, Zr, V, Mn, Fe, Co, Ni, Cu, Zn, B, Al, Ti, and a combination thereof.

70. The containment system of claim 40, wherein the metal organic framework particles comprise a moiety selected from the group consisting of a phenyl moiety, an imidazole moiety, a pyridine moiety, a pyrazole moiety, an oxole moiety, and a combination thereof.

71. (canceled)

72. (canceled)

73. A vehicle comprising the containment system of claim 1.

74. A method of manufacturing a vehicle comprising integrating the containment system of claim 1.

75. (canceled)

76. (canceled)

77. A method of operating a vehicle comprising controlling an amount of gas being utilized by a vehicle comprising the containment system of claim 1.

78. An adsorbed gas containment system comprising:
an adsorbed gas container containing adsorption particles; and
a pressure release device coupled to a wall of the container, the pressure release device having an exterior interface and an interior interface to allow for fluid communication between the interior and the exterior of the container upon activation, the interior interface comprising a filter basket in fluid communication with the exterior interface and extending into the interior of the container, the filter basket inhibiting exposure of the exterior interface with the particles.

79. A pressure release device comprising an exterior interface and an interior interface to allow for fluid communication between an interior and an exterior of a container upon activation, the interior interface comprising a filter basket in fluid communication with the exterior interface and adapted to extend into the interior of the container, the filter basket adapted with a mesh to inhibit exposure of the exterior interface with particles.

80. The pressure release device of claim 79, wherein a mesh size of the mesh has a diameter or largest width that is less than a mean diameter or smallest axis of the particles.
